(19) United States
(12) Patent Application Publication
(10) Pub. No.: US 2017/0193074 A1
(43) Pub. Date: Jul. 6, 2017

(54) Finding Related Articles for a Content Stream Using Iterative Merge-Split Clusters

(71) Applicant: Yahoo! Inc., Sunnyvale, CA (US)

(72) Inventors: Sainath Vellal, Sunnyvale, CA (US); Kostas Tsioutsiouliklis, San Jose, CA (US)

(21) Appl. No.: 14/985,302

(22) Filed: Dec. 30, 2015

(51) Int. Cl. G06F 17/30

(52) U.S. Cl. CPC G06F 17/30598; G06F 17/3033; G06F 17/30864; G06F 17/30516; G06F 17/30887

(57) ABSTRACT

Software generates an article signature for each article in a plurality of articles. The software initializes a clustering algorithm with a plurality of initial clusters that are non-overlapping. A centroid signature is generated for each initial cluster from the article signatures of the articles in the initial cluster. The software performs a succession of alternating merges and splits using the centroid signatures to create a plurality of non-overlapping coherent clusters from the plurality of initial clusters. The software identifies an article that is related to a specific article by mapping the article signature for the specific article to the centroid signature for at least one coherent cluster and comparing that article signature to the article signatures of the articles in the coherent cluster, using at least one similarity measure. The software displays the specific article and the related article in proximity to each other in a content stream.

### BACKGROUND

Facebook, Twitter, Google+, and other social networking websites present items of content including text, images, and videos to their users using a content stream that is in reverse-chronological order (e.g., with the topmost item in the stream being the last in time) or ordered according to an interestingness algorithm (e.g. with the topmost item in the stream having the highest interestingness score according to the algorithm) and/or a personalization algorithm.

Such content streams are now also used by websites hosting content-aggregation services such as Yahoo! News and Google News to present new articles (or stories).

Often a reader of a news article will want to dig deeper into the content of the article, e.g., for background or context. A link in the article might facilitate such activity, but it would probably navigate the reader away from the website and, importantly, the website's advertising.

### SUMMARY

In an example embodiment, a processor-executed method is described. According to the method, software running on servers at a website hosting a content-aggregation service generates an article signature for each article in a plurality of articles. The article signature is a vector of at least one phrase and a weight associated with the phrase. The weight is a measure of importance of the phrase to the article. The software initializes a clustering algorithm with a plurality of initial clusters that are non-overlapping. Each article in an initial cluster contains a specific phrase. And a centroid signature is generated for each initial cluster from the article signatures of the articles in the initial cluster. The software performs a succession of alternating merges and splits using the centroid signatures to create a plurality of non-overlapping coherent clusters from the plurality of initial clusters. Each merge employs locality sensitive hashing (LSH) to aggregate articles into a relatively smaller number of non-overlapping intermediate clusters. Each split aggregates articles into a relatively larger number of non-overlapping intermediate clusters. The centroid signature is recalculated, following each merge and following each split, from the article signatures of the articles in each intermediate cluster. The software identifies an article that is related to a specific article by mapping the article signature for the specific article to the centroid signature for at least one coherent cluster and comparing that article signature to the article signatures of the articles in the coherent cluster, using at least one similarity measure. Then the software displays the specific article and the related article in proximity to each other in a content stream.

In another example embodiment, an apparatus is described, namely, computer-readable media which persistently store a program that runs on a website hosting a content-aggregation service. The program generates an article signature for each article in a plurality of articles. The article signature is a vector of at least one phrase and a weight associated with the phrase. The weight is a measure of importance of the phrase to the article. The program initializes a clustering algorithm with a plurality of initial clusters that are non-overlapping. Each article in an initial cluster contains a specific phrase. And a centroid signature is generated for each initial cluster from the article signatures of the articles in the initial cluster. The program performs a succession of alternating merges and splits using the centroid signatures to create a plurality of non-overlapping coherent clusters from the plurality of initial clusters. Each merge employs locality sensitive hashing (LSH) to aggregate articles into a relatively smaller number of non-overlapping intermediate clusters, Each split aggregates articles into a relatively larger number of non-overlapping intermediate clusters. The centroid signature is recalculated, following each merge and following each split, from the article signatures of the articles in each intermediate cluster. The program identifies an article that is related to a specific article by mapping the article signature for the specific article to the centroid signature for at least one coherent cluster and comparing that article signature to the article signatures of the articles in the coherent cluster, using at least one similarity measure. Then the program displays the specific article and the related article in proximity to each other in a content stream.

Another example embodiment also involves a processor-executed method. According to the method, software running on servers at a website hosting a content-aggregation service generates an article signature for each article in a plurality of articles. The article signature is a vector of at least one phrase and a weight associated with the phrase. The weight is a measure of importance of the phrase to the article. The software initializes a clustering algorithm with a plurality of initial clusters that are non-overlapping. Each article in an initial cluster contains a specific phrase, And a centroid signature is generated for each initial cluster from the article signatures of the articles in the initial cluster. The software performs a succession of alternating merges and splits using the centroid signatures to create a plurality of non-overlapping coherent clusters from the plurality of initial clusters. Each merge employs locality sensitive hashing (LSH) to aggregate articles into a relatively smaller number of non-overlapping intermediate clusters, Each split aggregates articles into a relatively larger number of non-overlapping intermediate clusters. The centroid signature is recalculated, following each merge and following each split, from the article signatures of the articles in each intermediate cluster. The software identifies an article that is related to a specific article by mapping the article signature for the specific article to the centroid signature for at least one coherent cluster and comparing that article signature to the article signatures of the articles in the coherent cluster, using at least one similarity measure. Then the software determines that the related article is overly related to the specific article and removes the related article from a content stream in which the specific article is displayed.

### BRIEF DESCRIPTION OF THE DRAWINGS

FIG. 1 is a network diagram showing a website hosting a content-aggregation service, in accordance with an example embodiment.

FIG. 2 is a diagram showing an architecture for gathering articles for a content-aggregation service, in accordance with an example embodiment.

FIG. 3 is a diagram showing software modules for finding related articles using iterative merge-split clusters, in accordance with an example embodiment.

FIG. 4 is a flowchart diagram of a process for finding related articles, using a batch walker, to display in a content stream, in accordance with an example embodiment.

FIG. 5 shows a centroid signature for a cluster, in accordance with an example embodiment.

FIG. 6 shows a specific article and its related articles displayed in a content stream in a graphical user interface (GUI), in accordance with an example embodiment.

FIG. 7 is a flowchart diagram of a process for finding related articles, using an online walker, to display in a content stream, in accordance with an example embodiment.

FIG. 8 is a flowchart diagram of a process for finding related articles, using a batch walker, to remove from a content stream, in accordance with an example embodiment.

FIG. 9 is a flowchart diagram of a process for finding related articles, using an online walker, to remove from a content stream, in accordance with an example embodiment.

### DETAILED DESCRIPTION

In the following description, numerous specific details are set forth in order to provide a thorough understanding of the exemplary embodiments. However, it will be apparent to one skilled in the art that the example embodiments may be practiced without some of these specific details. In other instances, process operations and implementation details have not been described in detail, if already well known.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in an example embodiment” as used herein does not necessarily refer to the same embodiment and the phrase “in another example embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

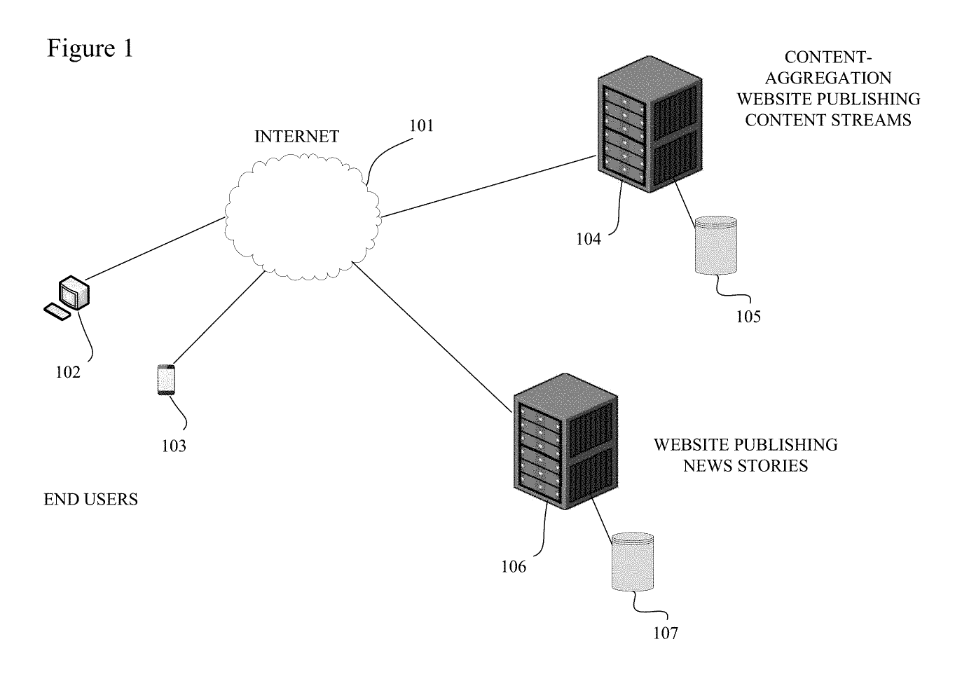

FIG. 1 is a network diagram showing a website hosting a content-aggregation service, in accordance with an example embodiment. As depicted in this figure, a personal computer 102 (e.g., a laptop or other mobile computer) and a mobile device 103 (e.g., a smartphone such as an iPhone, Android, Windows Phone, etc., or a tablet computer such as an iPad, Galaxy, etc.) are connected by a network 101 (e.g., a wide area network (WAN) including the Internet, which might be wireless in part or in whole) with a website 104 hosting a content-aggregation service that publishes a content stream and a website 106 publishing news articles (e.g., the website for the New York Times). In an example embodiment, website 104 might be a website such as Yahoo! News or Google News, which ingests content from the Internet through “push” technology (e.g., a subscription to a web feed such as an RSS feed) and/or “pull” technology (e.g., web crawling), including news articles (or Uniform Resource Locators (URLs) for news articles) from website 106.

Alternatively, in an example embodiment, website 104 might host an online social network such as Facebook or Twitter. As used here and elsewhere in this disclosure, the term “online social network” is to be broadly interpreted to include, for example, any online service, including a social-media service, that allows its users to, among other things, (a) selectively access (e.g., according to a friend list, contact list, buddy list, social graph, interest graph, or other control list) content (e.g., text including web links, images, videos, animations, audio recordings, games and other software, etc.) associated with each other's profiles (e.g., Facebook walls, Flickr photo albums, Pinterest boards, etc.); (b) selectively (e.g., according to a friend list, contact list, buddy list, social graph, interest graph, distribution list, or other control list) broadcast content (e.g., text including web links, images, videos, animations, audio recordings, games and other software, etc.) to each other's newsfeeds (e.g., content/activity streams such as Facebook's News Feed, Twitter's Timeline, Google+'s Stream, etc.); and/or (c) selectively communicate (e.g., according to a friend list, contact list, buddy list, social graph, interest graph, distribution list, or other control list) with each other (e.g., using a messaging protocol such as email, instant messaging, short message service (SMS), etc.).

And as used in this disclosure, the term “content-aggregation service” is to be broadly interpreted to include any online service, including a social-media service, that allows its users to, among other things, access and/or annotate (e.g., comment on) content (e.g., text including web links, images, videos, animations, audio recordings, games and other software, etc.) aggregated/ingested by the online service (e.g., using its own curators and/or its own algorithms) and/or its users and presented in a “wall” view or “stream” view. It will be appreciated that a website hosting a content-aggregation service might have social features based on a friend list, contact list, buddy list, social graph, interest graph, distribution list, or other control list that is accessed over the network from a separate website hosting an online social network through an application programming interface (API) exposed by the separate website. Thus, for example, Yahoo! News might identify the content items in its newsfeed (e.g., as displayed on the front page of Yahoo! News) that have been viewed/read by a user's friends, as listed on a Facebook friend list that the user has authorized Yahoo! News to access.

In an example embodiment, websites 104 and 106 might be composed of a number of servers (e.g., racked servers) connected by a network (e.g., a local area network (LAN) or a WAN) to each other in a cluster (e.g., a load-balancing cluster, a Beowulf cluster, a Hadoop cluster, etc.) or other distributed system which might run website software (e.g., web-server software, database software, search-engine software, etc.), and distributed-computing and/or cloud software such as Map-Reduce, Google File System, Hadoop, Hadoop File System, Pig, Hive, Dremel, CloudBase, etc. The servers in website 104 might be connected to persistent storage 105 and the servers in website 106 might be connected to persistent storage 107. Persistent storages 105 and 107 might include flash memory, a redundant array of independent disks (RAID), and/or a storage area network (SAN), in an example embodiment. In an alternative example embodiment, the servers for websites 104 and 106 and/or the persistent storage in persistent storages 105 and 107 might be hosted wholly or partially in a public and/or private cloud, e.g., where the cloud resources serve as a platform-as-a-service (PaaS) or an infrastructure-as-a-service (IaaS).

Persistent storages 105 and 107 might be used to store content (e.g., text including web links, images, videos, animations, audio recordings, games and other software, etc.) and/or its related data. Additionally, persistent storage 105 might be used to store data related to users and their social contacts (e.g., Facebook friends), as well as software including algorithms and other processes, as described in detail below, for presenting the content (including related articles) to the users in a content stream. In an example embodiment, the content stream might be ordered from top to bottom (a) in reverse chronology (e.g., latest in time on top), or (b) according to interestingness scores. In an example embodiment, some of the content (and/or its related data) stored in persistent storages 105 and 107 might have been received from a content delivery or distribution network (CDN), e.g., Akami Technologies. Or, alternatively, some of the content (and/or its related data) might be delivered directly from the CDN to the personal computer 102 or the mobile device 103, without being stored in persistent storages 105 and 107.

Personal computer 102 and the servers at websites 104 and 106 might include (1) hardware consisting of one or more microprocessors (e.g., from the x86 family, the ARM family, or the PowerPC family), volatile storage (e.g., RAM), and persistent storage (e.g., flash memory, a hard disk, or a solid-state drive), and (2) an operating system (e.g., Windows, Mac OS, Linux, Windows Server, Mac OS Server, etc.) that runs on the hardware. Similarly, in an example embodiment, mobile device 103 might include (1) hardware consisting of one or more microprocessors (e.g., from the ARM family or the x86 family), volatile storage (e.g., RAM), and persistent storage (e.g., flash memory such as microSD), (2) an operating system (e.g., iOS, webOS, Windows Mobile, Android, Linux, Symbian OS, RIM BlackBerry OS, etc.) that runs on the hardware, and (3) one or more accelerometers, one or more gyroscopes, global positioning system (GPS) or other location-identifying type capability.

Also in an example embodiment, personal computer 102 and mobile device 103 might each include a browser as an application program or as part of an operating system. Examples of browsers that might execute on personal computer 102 include Internet Explorer, Mozilla Firefox, Safari, and Google Chrome. Examples of browsers that might execute on mobile device 103 include Safari, Mozilla Firefox, Android Browser, and webOS Browser. It will be appreciated that users of personal computer 102 and/or mobile device 103 might use browsers to access content presented by websites 104 and 106. Alternatively, users of personal computer 102 and/or mobile device 103 might use application programs (or apps, including hybrid apps that display HTML content) to access content presented by websites 104 and 106.

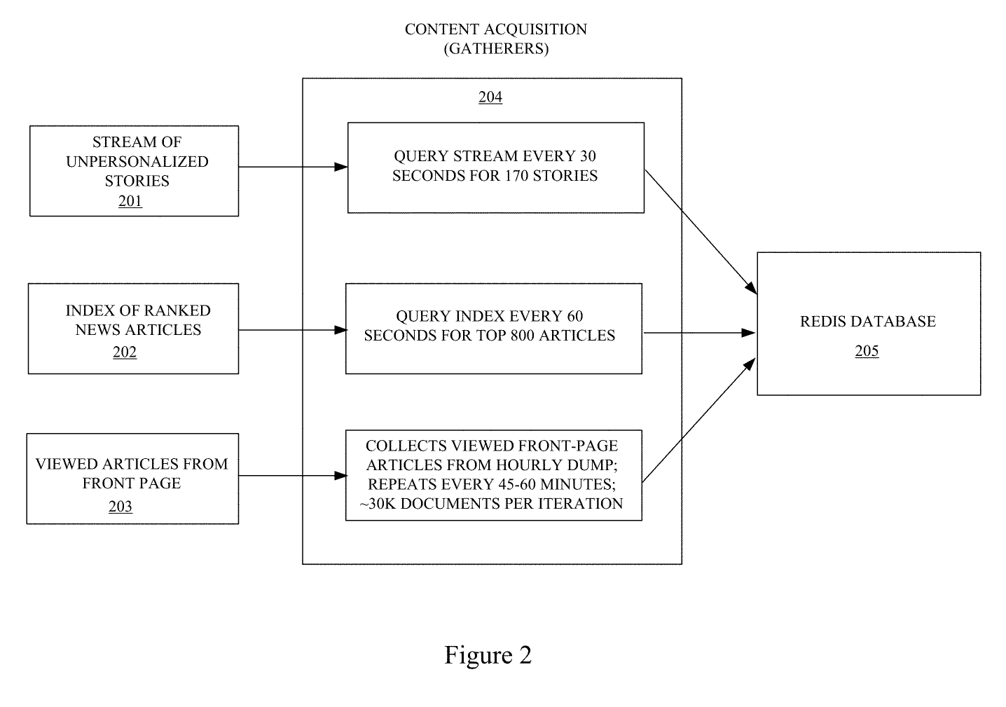

FIG. 2 is a diagram showing an architecture for gathering articles for a content-aggregation service, in accordance with an example embodiment. As shown in this figure, software 204 executing on a website 104 hosting a content-aggregation service acquires articles (or stories) for a content stream presented to a user of a client device (e.g., personal computer 102 or mobile device 103). In an example embodiment, the content stream might be personalized using a user's personalization profile, e.g., if the user logs on to the content-aggregation service or otherwise makes himself or herself known to the content-aggregation service (e.g., through identifying data stored on a client device such as an Android Advertising ID). The personalization profile might include the user's stored preferences and/or viewing history (e.g., articles the user clicked on, hovered over for a specified number of seconds, viewed for a specified number of seconds, dwelled on for a specified number of seconds, etc.). In an example embodiment, a user's personalization profile might be used in conjunction with content-based filtering, collaborative filtering, or hybrid content-based and collaborative filtering of articles to be displayed in the user's personalized content stream.

Also, in an example embodiment, the software 204 might acquire (or gather) the articles from at least three sources: (a) a stream 201 of unpersonalized stories; (b) an index 202 of ranked news articles 202; and (c) an hourly dump 203 of viewed articles from a front page for the content-aggregation service, e.g., a front page that is displayed on a client device. Also, in an example embodiment, all three of these sources might be a part of the content-aggregation service. That is to say, they might be generated by software running on servers that are a part of website 104 and the sources might be stored in persistent storage 105.

As also shown in FIG. 2, software 204 might query the stream 201 for approximately 170 unpersonalized stories every 30 seconds, in an example embodiment. Similarly, software 204 might query the index 202 for approximately the top 800 articles every 60 seconds, in an example embodiment. And software 204 might collect approximately 30,000 documents from the hourly dump 203 of viewed front-page articles every 45-60 minutes, in an example embodiment. Software 204 might then store the acquired articles (or stories) in a Redis (e.g., Redis.io) database/cache, where they can be used to generate the content stream served to a client device as described in further detail below. In an example embodiment, the Redis database/cache might consists of key-value pairs and be wholly or partially an in-memory database/cache.

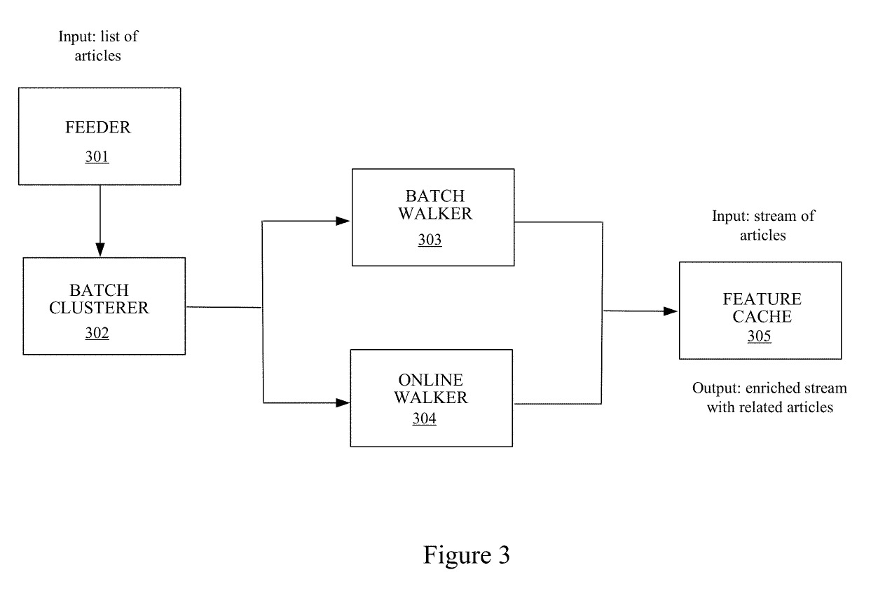

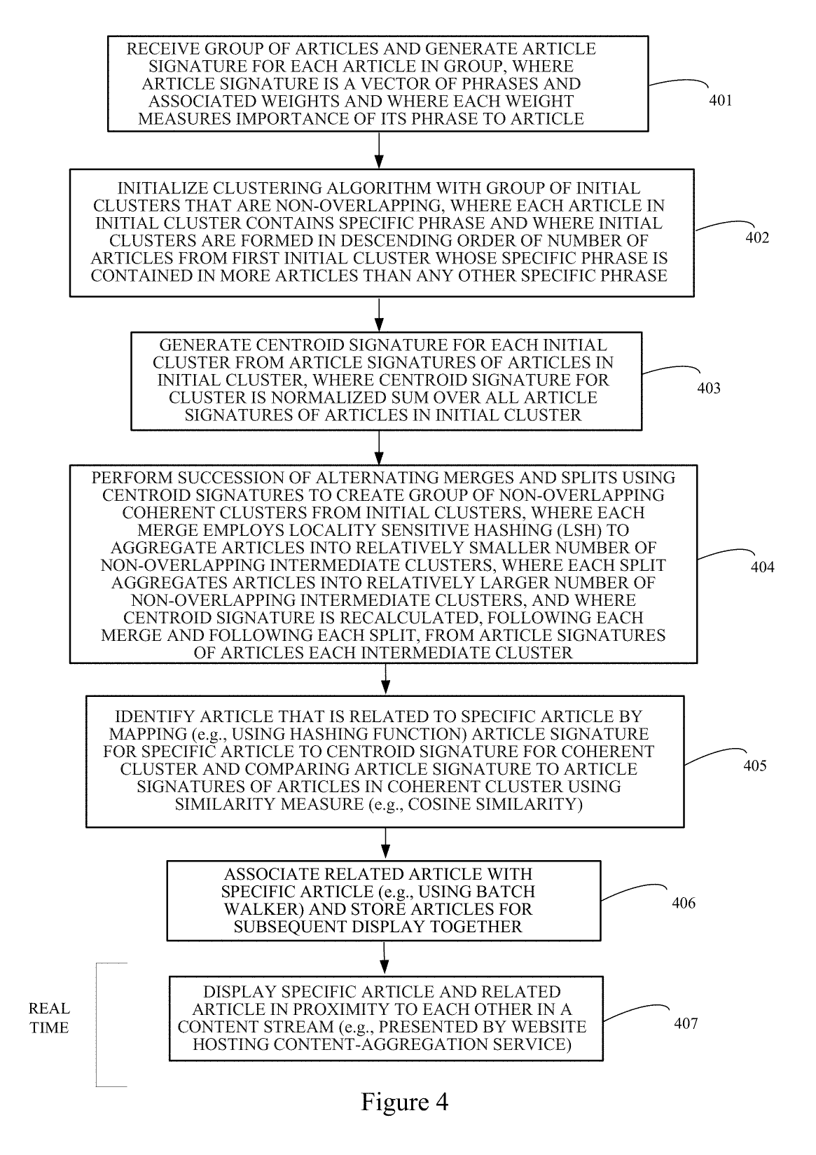

FIG. 3 is a diagram showing software modules for finding related articles using iterative merge-split clusters, in accordance with an example embodiment. As shown in this figure, the input to the software modules is a list of articles, e.g., the articles that are stored in Redis database/cache 205 following acquisition as described in FIG. 2. In an example embodiment, the feeder module 301 might obtain the articles from the Redis database/cache and then transmit them to batch clusterer 302, where the operations 401-404 in FIG. 4 and operations 801-804 might be performed to create coherent clusters of articles. In an example embodiment, those coherent clusters might then be used offline by a batch walker 303 or online (e.g., in real-time) by a online walker 304 to generate related articles for a specific article. In an example embodiment, the operations performed by batch walker 303 and online walker 304 might be parallelized, e.g., using a Hadoop cluster with each node having less than all of the coherent clusters. Then the specific article and its related articles might be stored in a feature cache 305, which might also be a Redis database/cache that is wholly or partially in-memory, in an example embodiment. From there, the specific article and its related articles can be used in real-time by software for the content-aggregation service to enrich a content stream lacking related articles (e.g., a content stream also generated from the articles in Redis database/cache 205 in FIG. 2), prior to transmission to a client device.

FIG. 4 is a flowchart diagram of a process for finding related articles, using a batch walker (e.g., as described above with reference to FIG. 3), to display in a content stream, in accordance with an example embodiment. In an example embodiment, the operations shown in this figure might be performed by software running on servers at website 104 (e.g., Yahoo! News, Google News, Facebook, Twitter, etc.) using persistent storage 105. In an alternative example embodiment, some of the operations shown in this figure might be performed by software (e.g., a client application including, for example, a webpage with embedded JavaScript or ActionScript) running on a client device (e.g., personal computer 102 or mobile device 103).

As depicted in FIG. 4, the software (e.g., the software running on servers at website 104) receives a group of articles (e.g., from feeder 301 in FIG. 3) and generates an article signature for each article in the group, in operation 401. In an example embodiment, the article signature is a vector of phrases (e.g., one or more words) and associated weights, where each weight measures the importance of its associated phrase to the article. In operation 402, the software initializes a clustering algorithm with a group of initial clusters that are non-overlapping. In an example embodiment, each article in an initial cluster contains a specific phrase (e.g., “charleston massacre”) and the initial clusters are formed in descending order of number of articles (e.g., 210, 156, 75, etc.) from a first initial cluster whose specific phrase (e.g., “charleston massacre”) is contained in more articles than any other specific phrase. In operation 403, the software generates a centroid signature for each initial cluster from the article signatures of the articles in the initial cluster. In an example embodiment, the centroid signature for a cluster is a normalized sum over all of the article signatures of the articles in the initial cluster. The software then performs a succession of alternating merges and splits using the centroid signatures to create group of non-overlapping coherent clusters from the initial clusters, in operation 404. In an example embodiment, each merge employs locality sensitive hashing (LSH) to aggregate articles into a relatively smaller number of non-overlapping intermediate clusters and each split aggregates articles into a relatively larger number of non-overlapping intermediate clusters. It will be appreciated that LSH might utilize a number of hashing functions to map a single article to a number of clusters, in an example embodiment. The centroid signature is recalculated, following each merge and following each split, from the article signatures of the articles in each intermediate cluster, in an example embodiment. In operation 405, the software identifies an article that is related to a specific article (e.g., an article on the Charleston shooting) by mapping (e.g., using a hashing function) the article signature for the specific article to a centroid signature for a coherent cluster and comparing the article signature to the article signatures of the articles in the coherent cluster, using a similarity measure (e.g., cosine similarity). The software associates the related article with the specific article (e.g., using batch walker 303 in FIG. 3) and stores the articles for subsequent display together in a content stream, in operation 406. Then in operation 407, the software displays the specific article (e.g., an article on the Charleston shooting) and the related article (e.g., another article on the Charleston shooting) in proximity to each other in a content stream (e.g., generated by the website hosting the content-aggregation service). As indicated in FIG. 4, operation 407 might be performed in real-time, in an example embodiment.

As noted above, the software generates an article signature for each article in the group, in operation 401. In an example embodiment, an article signature might include one or more of the following items of metadata (or phrases) derived from the article: (a) a phrase (e.g., one or more words) from the uniform resource locator (URL) for the webpage containing the article; (b) nouns that are designated (e.g., in a markup language such as HTML) as title nouns for the webpage containing the article; (c) named entities (e.g., where an named entity identifies a person, location, or organization) identified in the body of the article; (d) concepts derived from the article and found in a knowledge base (e.g., a corpus such as Wikipedia) maintained by the content-aggregation service; and (e) category and/or taxonomy labels (e.g., as generated by classifiers supervised by humans) derived from the article and found in a taxonomy maintained by the content-aggregation service.

In an example embodiment, the metadata items in (a) might be “newsy tokens” that are extracted from the URL and stored on a white-list. For example, the software might split the URL into sections using its slash characters (“/”) and non-alphabetic characters, tokenize the sections, and keep only the tokens for the section that has the most tokens. So, the URL “http;//www.yahoo.com/7-most-amazing-iphone-apps/index.html” might yield four tokens that are white-listed and considered newsy: “most”, “amazing”, “iphone”, and “apps”. The same URL might yield three tokens that are black-listed, considered non-newsy, and removed: “www”, “yahoo”, and “com”. Also, in an example embodiment, stop words might also be black-listed, considered non-newsy, and removed.

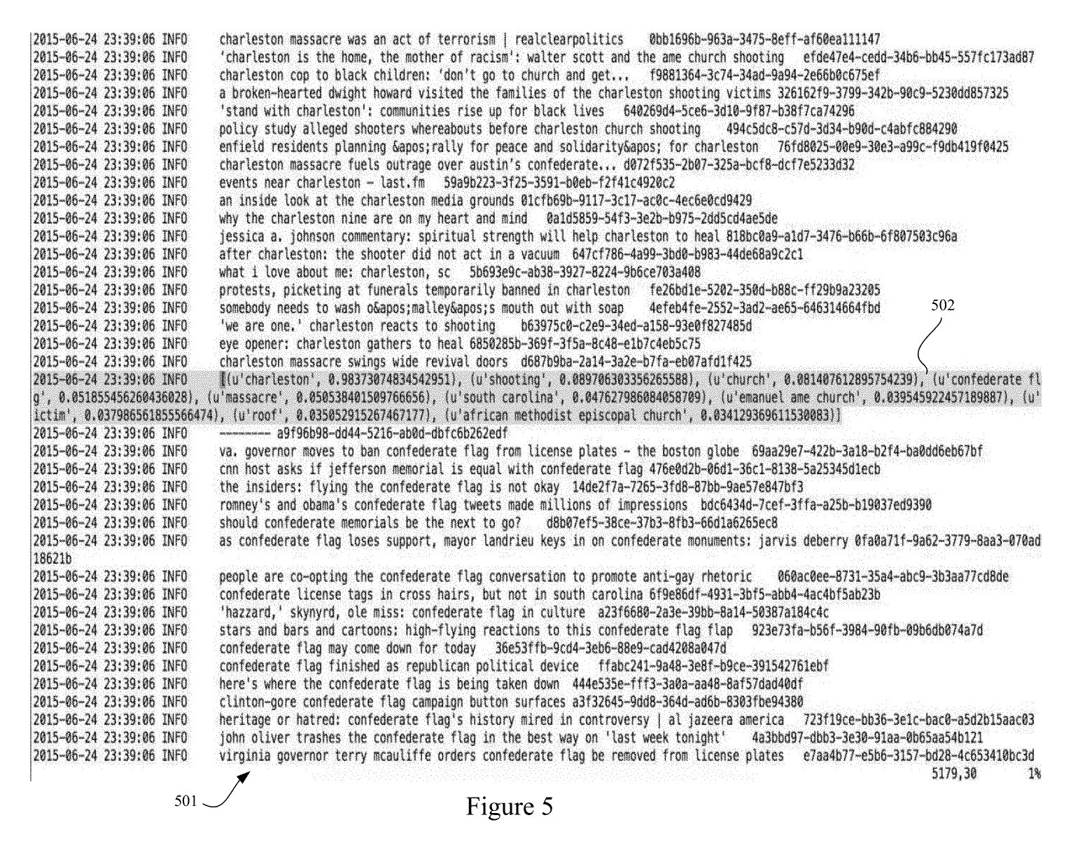

Further, in an example embodiment, the software might create a vector from each metadata item (or phrase) in (a)-(e). Each metadata item (or phrase) might be associated with a weight (e.g., on a decimal scale) that measures the importance of the item to the article. For example, each title noun in (b) might receive a relatively high weight of 0.8. And newsy tokens in (a) might receive an even relatively higher weight of 2.0. In an example embodiment, the software might then order the metadata items (or phrases) by weight and use the top 15 ordered metadata items (phrases) and their weights to create a vector that represents the signature for the article. In this regard, see the signature in FIG. 5, which is actually a centroid signature rather than an article signature, though the two types of signature might share a similar structure, in an example embodiment. In another example embodiment, the vector might only include the ordered phrases without their weights. It will be appreciated that the article signature (and/or the vector) is an automatically-generated (e.g., created without human supervision) tag or label for the article from which it was derived and that such a tag or label is useful for collecting personalization interests for a user (e.g., the tag or label might be incorporated into a user's personalization profile as described above).

As also noted above, the software generates a centroid signature for each initial cluster from the article signatures of the articles in the initial cluster, in operation 403, where the centroid signature is a normalized sum over all of the article signatures of the articles in the initial cluster. In an example embodiment, the same calculation might be used for the centroid signature for an intermediate cluster and the centroid signature for a coherent cluster. That is to say, in an example embodiment, the centroid signature for an initial cluster, an intermediate cluster, or a coherent cluster might be a normalized sum over all of the article signatures of the articles in the cluster. In an alternative example embodiment, the centroid signature for a cluster might be a normalized average (or normalized union, normalized concatenation, etc.) of all of the article signatures of the articles in the cluster. Further, a normalized sum might be used for an initial cluster, a normalized average might be used for an intermediate cluster, a normalized union might be used for a coherent cluster, etc.

As noted above, the software performs a succession of alternating merges and splits using centroid signatures to create a group of non-overlapping coherent clusters from the initial clusters, in operation 404. In an example embodiment, the succession of alternating merges and splits might include the following operations in the following order: (1) a merge based on LSH, using an un-augmented centroid signature for each initial cluster; (2) a split based on LSH, using an un-augmented centroid signature for each intermediate cluster; (3) a merge based on LSH, using a centroid signature for each intermediate cluster augmented (or bloated) with additional important phrases (e.g., in various possible combinations) from the intermediate cluster's article signatures; (4) a split based on cosine similarity, using an un-augmented centroid signature for each intermediate cluster; (5) a merge based on LSH, using a centroid signature for each intermediate cluster augmented (or bloated) with additional important phrases (e.g., the top 15 phrases in various possible combinations) from the previous centroid signature; (6) a split based on cosine similarity, using an un-augmented centroid signature for each intermediate cluster; (7) a merge based on LSH, using an un-augmented centroid signature for each intermediate cluster; (8) a split based on cosine similarity, using an un-augmented centroid signature for each intermediate cluster; and (9) a merge based on LSH, using a centroid signature for each intermediate cluster augmented (or bloated) with additional important phrases (e.g., the top 15 phrases in various possible combinations) from the previous centroid signature. In other example embodiments, the succession of alternating merges and splits might include some or all of the above merges and splits in a different order. Similarly, in an example embodiment, the succession of alternating merges and splits might use merges with centroid signatures augmented (or bloated) with one or more of the metadata items (or phrases) described above, e.g., metadata items (a)-(e). Also, in an example embodiment, the splits might be parallelized, e.g., using a Hadoop cluster.

In an alternative example embodiment, the software, when performing operation (3), might use the important phrases (e.g., in various possible combinations) from the intermediate cluster's article signatures as the centroid signature, without resort to any phrases in the intermediate cluster's previous centroid signature. Similarly, in an alternative example embodiment, the software, when performing operations (5) and (9), might use the top (e.g., top 15) important phrases (e.g., in various possible combinations) from the intermediate cluster's previous centroid signature as the centroid signature, without resort to any other phrases in the intermediate cluster's previous centroid signature.

In an example embodiment, the merge in operation (1) and the split in operation (2) might be performed using different hashing functions or using the same hashing function(s) with a different similarity threshold. In this regard, it will be appreciated that LSH approximates Jaccard similarity. Consequently, if the similarity threshold is set relatively low (e.g., the threshold is met when the similarity between an article and a centroid signature is relatively small), application of LSH to the articles in the clusters (e.g., mapping each article to a centroid signature for a non-overlapping cluster using the same hash function(s)) might aggregate the articles into a relatively smaller number of clusters. By contrast, if the similarity threshold is set relatively high (e.g., the threshold is met when the similarity between an article and a centroid signature is relatively large), application of LSH to the articles in the clusters (e.g., mapping each article to a centroid signature for a non-overlapping cluster using the same hash function(s)) might aggregate the articles into a relatively larger number of clusters.

Also, in an example embodiment, the splits in operations (4), (6), and (8) might be performed by calculating cosine similarity between an intermediate cluster's centroid signature and each article in the intermediate cluster. Then, the articles with low similarity to the centroid signature might be removed from the intermediate cluster and treated as singletons, for purposes of the upcoming merge operation, and the articles with high similarity to the centroid signature might be used to calculate the new centroid signature.

Also, as noted above, the software, in operation 405, identifies an article that is related to a specific article by mapping (e.g., using a hashing function) the article signature for the specific article to a centroid signature for a coherent cluster and comparing the article signature to the article signatures of the articles in the coherent cluster, using a similarity measure (e.g., cosine similarity). In an example embodiment, an article in the coherent cluster might be deemed a “related article” if its article signature has a high value for pair-wise cosine similarity (e.g., in the range 0.7-0.9) to the article signature for the specific article. If the value for pair-wise cosine similarity is too high (e.g., the important phrases in the article signature for the related article are the same as the important phrases in the article signature for the specific article), the related article might be discarded as a duplicate (or dup), as described in further detail below. In an example embodiment, a duplicate or (dup) might not be an exact duplicate.

It will be appreciated that a specific article might be mapped to a relatively small number of coherent clusters, rather than one coherent cluster, in an example embodiment. In that event, the software might use a Jaccard similarity determination to eliminate some of those coherent clusters, in an example embodiment. So, for example, the article signature for the specific article might be compared to the centroid signature for a coherent cluster to which the specific article was mapped (e.g., by a hashing function). If the article signature for the specific article has a low value for pair-wise Jaccard similarity to the centroid signature for a coherent cluster, the software might skip that coherent cluster when performing the cosine similarity comparisons between article signatures.

It will be appreciated that the process described in FIG. 4 approximates a time efficiency of O(n) rather than O(n²) in terms of Big-O notation, even when using cosine similarity as the similarity measure, due to a reduction in pair-wise comparisons (e.g., as a result of mapping the specific article to a relatively small number of coherent clusters).

FIG. 5 shows a centroid signature for a cluster, in accordance with an example embodiment. As shown in this figure, list 501 is a list of articles that have been clustered using a process similar to the process shown in FIG. 4. Centroid signature 502 (which is highlighted) includes numerous phrases from the articles in list 501 in a vector where each phrase is paired with its importance score, in descending order with the highest importance score towards the left of the vector and the lowest importance score towards the right of the vector. In an example embodiment, each of these importance scores might be a normalized sum of the importance scores for the phrase in the articles in the cluster. It will be appreciated that centroid signature 502 is an automatically-generated (e.g., created without human supervision) tag or label for the articles in the cluster.

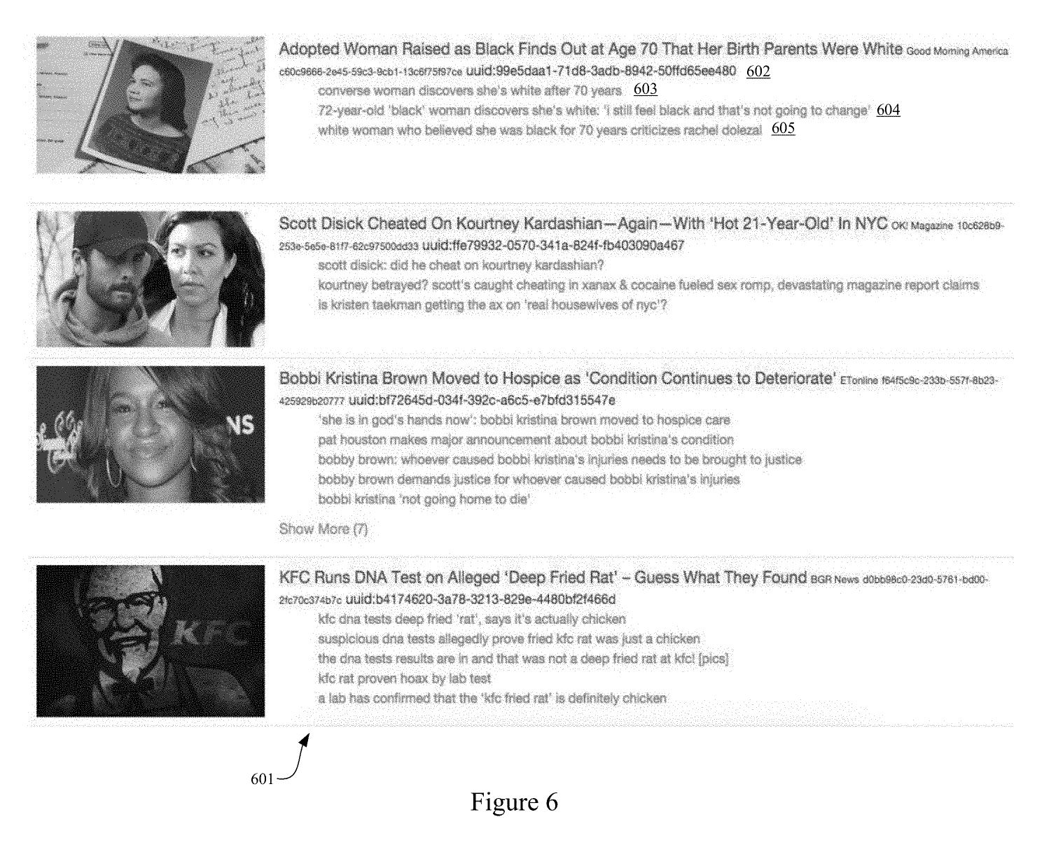

FIG. 6 shows a specific article and its related articles displayed in a content stream in a graphical user interface (GUI), in accordance with an example embodiment. As shown in this figure, a content stream 601 is generated by a content-aggregation service and includes four articles (or stories). The topmost article 602 is identified by a lengthy “uuid” and is associated with three related articles 603, 604, and 605 that have been found using a process similar to the process shown in FIG. 4. It will be appreciated that the uuid for article 602 is shown for demonstrative purposes and would probably not be displayed to a user of the content-aggregation service.

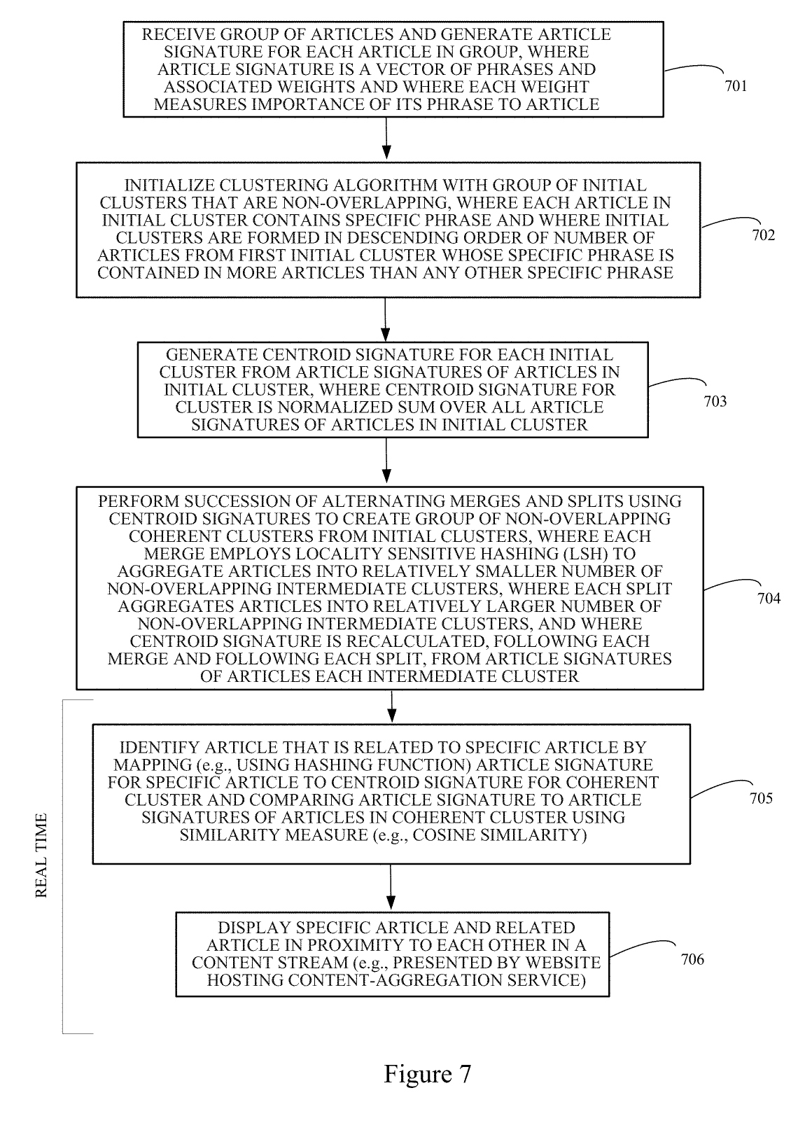

FIG. 7 is a flowchart diagram of a process for finding related articles, using an online walker, to display in a content stream, in accordance with an example embodiment. In an example embodiment, the operations shown in this figure might be performed by software running on servers at website 104 (e.g., Yahoo! News, Google News, Facebook, Twitter, etc.) using persistent storage 105. In an alternative example embodiment, some of the operations shown in this figure might be performed by software (e.g., a client application including, for example, a webpage with embedded JavaScript or ActionScript)) running on a client device (e.g., personal computer 102 or mobile device 103).

As depicted in FIG. 7, the software (e.g., the software running on servers at website 104) receives a group of articles (e.g., from feeder 301 in FIG. 3) and generates an article signature for each article in the group, in operation 701. In an example embodiment, the article signature is a vector of phrases (e.g., one or more words) and associated weights, where each weight measures the importance of its associated phrase to the article. In operation 702, the software initializes a clustering algorithm with a group of initial clusters that are non-overlapping. In an example embodiment, each article in an initial cluster contains a specific phrase (e.g., “charleston massacre”) and the initial clusters are formed in descending order of number of articles (e.g., 210, 156, 75, etc.) from a first initial cluster whose specific phrase (e.g., “charleston massacre”) is contained in more articles than any other specific phrase. In operation 703, the software generates a centroid signature for each initial cluster from the article signatures of the articles in the initial cluster. In an example embodiment, the centroid signature for a cluster is a normalized sum over all of the article signatures of the articles in the initial cluster. The software then performs a succession of alternating merges and splits using the centroid signatures to create group of non-overlapping coherent clusters from the initial clusters, in operation 704. In an example embodiment, each merge employs locality sensitive hashing (LSH) to aggregate articles into a relatively smaller number of non-overlapping intermediate clusters and each split aggregates articles into a relatively larger number of non-overlapping intermediate clusters. It will be appreciated that LSH might utilize a number of hashing functions to map a single article to a number of clusters, in an example embodiment. The centroid signature is recalculated, following each merge and following each split, from the article signatures of the articles in each intermediate cluster, in an example embodiment. In operation 705, the software identifies an article that is related to a specific article (e.g., an article on the Charleston shooting) by mapping (e.g., using a hashing function) the article signature for the specific article to a centroid signature for a coherent cluster and comparing the article signature to the article signatures of the articles in the coherent cluster, using a similarity measure (e.g., cosine similarity). Then in operation 706, the software displays the specific article (e.g., an article on the Charleston shooting) and the related article (e.g., another article on the Charleston shooting) in proximity to each other in a content stream (e.g., generated by the website hosting the content-aggregation service). As indicated in FIG. 4, operations 705 and 706 might be performed in real-time, in an example embodiment.

As noted above, the software displays the specific article (e.g., an article on the Charleston shooting) and the related article (e.g., another article on the Charleston shooting) in proximity to each other in a content stream (e.g., generated by the website hosting the content-aggregation service), in operation 706.

As noted above, the software generates an article signature for each article in the group, in operation 701. Here again, in an example embodiment, an article signature might include one or more of the following items of metadata (or phrases) derived from the article: (a) a phrase (e.g., one or more words) from the uniform resource locator (URL) for the webpage containing the article; (b) nouns that are designated (e.g., in a markup language such as HTML) as title nouns for the webpage containing the article; (c) named entities (e.g., where an named entity identifies a person, location, or organization) identified in the body of the article; (d) concepts derived from the article and found in a knowledge base (e.g., a corpus such as Wikipedia) maintained by the content-aggregation service; and (e) category and/or taxonomy labels (e.g., as generated by classifiers supervised by humans) derived from the article and found in a taxonomy maintained by the content-aggregation service.

In an example embodiment, the metadata items in (a) might be “newsy tokens” that are extracted from the URL and stored on a white-list. For example, the software might split the URL into sections using its slash characters (“/”) and non-alphabetic characters, tokenize the sections, and keep only the tokens for the section that has the most tokens. So, the URL “http;//www.yahoo.com/7-most-amazing-iphone-apps/index.html” might yield four tokens that are white-listed and considered newsy: “most”, “amazing”, “iphone”, and “apps”. The same URL might yield three tokens that are black-listed, considered non-newsy, and removed: “www”, “yahoo”, and “com”. Also, in an example embodiment, stop words might also be black-listed, considered non-newsy, and removed.

Further, in an example embodiment, the software might create a vector from each metadata item (or phrase) in (a)-(e). Each metadata item (or phrase) might be associated with a weight (e.g., on a decimal scale) that measures the importance of the item to the article. For example, each title noun in (b) might receive a relatively high weight of 0.8. And newsy tokens in (a) might receive an even relatively higher weight of 2.0. In an example embodiment, the software might then order the metadata items (or phrases) by weight and use the top 15 ordered metadata items (phrases) and their weights to create a vector that represents the signature for the article. In this regard, see the signature in FIG. 5, which is actually a centroid signature rather than an article signature, though the two types of signature might share a similar structure, in an example embodiment. In another example embodiment, the vector might only include the ordered phrases without their weights. It will be appreciated that the article signature (and/or the vector) is an automatically-generated (e.g., created without human supervision) tag or label for the article from which it was derived.

As also noted above, the software generates a centroid signature for each initial cluster from the article signatures of the articles in the initial cluster, in operation 403, where the centroid signature for a cluster is a normalized sum over all of the article signatures of the articles in the initial cluster. In an example embodiment, the same calculation might be used for the centroid signature for an intermediate cluster and the centroid signature for a coherent cluster. That is to say, in an example embodiment, the centroid signature for an initial cluster, an intermediate cluster, or a coherent cluster might be a normalized sum over all of the article signatures of the articles in the cluster. In an alternative example embodiment, the centroid signature for al cluster might be a normalized average (or normalized union, normalized concatenation, etc.) of all of the article signatures of the articles in the cluster. Further, a normalized sum might be used for an initial cluster, a normalized average might be used for an intermediate cluster, a normalized union might be used for a coherent cluster, etc.

As noted above, the software performs a succession of alternating merges and splits using centroid signatures to create a group of non-overlapping coherent clusters from the initial clusters, in operation 704. Here again, in an example embodiment, the succession of alternating merges and splits might include the following operations in the following order: (1) a merge based on LSH, using an un-augmented centroid signature for each initial cluster; (2) a split based on LSH, using an un-augmented centroid signature for each intermediate cluster; (3) a merge based on LSH, using a centroid signature for each intermediate cluster augmented (or bloated) with additional important phrases (e.g., in various possible combinations) from the intermediate cluster's article signatures; (4) a split based on cosine similarity, using an un-augmented centroid signature for each intermediate cluster; (5) a merge based on LSH, using a centroid signature for each intermediate cluster augmented (or bloated) with additional important phrases (e.g., the top 15 phrases in various possible combinations) from the previous centroid signature; (6) a split based on cosine similarity, using an un-augmented centroid signature for each intermediate cluster; (7) a merge based on LSH, using an un-augmented centroid signature for each intermediate cluster; (8) a split based on cosine similarity, using an un-augmented centroid signature for each intermediate cluster; and (9) a merge based on LSH, using a centroid signature for each intermediate cluster augmented (or bloated) with additional important phrases (e.g., the top 15 phrases in various possible combinations) from the previous centroid signature. In other example embodiments, the succession of alternating merges and splits might include some or all of the above merges and splits in a different order. Similarly, in an example embodiment, the succession of alternating merges and splits might use merges with centroid signatures augmented (or bloated) with one or more of the metadata items (or phrases) described above, e.g., metadata items (a)-(e). Also, in an example embodiment, the splits might be parallelized, e.g., using a Hadoop cluster.

In an alternative example embodiment, the software, when performing operation (3), might use the important phrases (e.g., in various possible combinations) from the intermediate cluster's article signatures as the centroid signature, without resort to any phrases in the intermediate cluster's previous centroid signature. Similarly, in an alternative example embodiment, the software, when performing operations (5) and (9), might use the top (e.g., top 15) important phrases (e.g., in various possible combinations) from the intermediate cluster's previous centroid signature as the centroid signature, without resort to any other phrases in the intermediate cluster's previous centroid signature.

In an example embodiment, the merge in operation (1) and the split in operation (2) might be performed using different hashing functions or using the same hashing function(s) with a different similarity threshold. In this regard, it will be appreciated that LSH approximates Jaccard similarity. Consequently, if the similarity threshold is set relatively low (e.g., the threshold is met when the similarity between an article and a centroid signature is relatively small), application of LSH to the articles in the clusters (e.g., mapping each article to a centroid signature for a non-overlapping cluster using the same hash function(s)) might aggregate the articles into a relatively smaller number of clusters. By contrast, if the similarity threshold is set relatively high (e.g., the threshold is met when the similarity between an article and a centroid signature is relatively large), application of LSH to the articles in the clusters (e.g., mapping each article to a centroid signature for a non-overlapping cluster using the same hash function(s)) might aggregate the articles into a relatively larger number of clusters.

Also, in an example embodiment, the splits in operations (4), (6), and (8) might be performed by calculating cosine similarity between an intermediate cluster's centroid signature and each article in the intermediate cluster. Then, the articles with low similarity to the centroid signature might be removed from the intermediate cluster and treated as singletons, for purposes of the upcoming merge operation, and the articles with high similarity to the centroid signature might be used to calculate the new centroid signature.

Also, as noted above, the software, in operation 705, identifies an article that is related to a specific article by mapping (e.g., using a hashing function) the article signature for the specific article to a centroid signature for a coherent cluster and comparing the article signature to the article signatures of the articles in the coherent cluster, using a similarity measure (e.g., cosine similarity). Here again, in an example embodiment, an article in the coherent cluster might be deemed a “related article” if its article signature has a high value for pair-wise cosine similarity (e.g., in the range 0.7-0.9) to the article signature for the specific article. If the value for pair-wise cosine similarity is too high (e.g., the important phrases in the article signature for the related article are the same as the important phrases in the article signature for the specific article), the related article might be discarded as a duplicate (or dup). In an example embodiment, a duplicate or (dup) might not be an exact duplicate. In an example embodiment, operation 705 might be performed by online walker 304 in FIG. 3.

Here again, it will be appreciated that a specific article might be mapped to a relatively small number of coherent clusters, rather than one coherent cluster, in an example embodiment. In that event, the software might use a Jaccard similarity determination to eliminate some of those coherent clusters, in an example embodiment. So, for example, the article signature for the specific article might be compared to the centroid signature for a coherent cluster to which the specific article was mapped (e.g., by a hashing function). If the article signature for the specific article has a low value for pair-wise Jaccard similarity to the centroid signature for a coherent cluster, the software might skip that coherent cluster when performing the cosine similarity comparisons between article signatures.

Here again, it will be appreciated that the process described in FIG. 7 approximates a time efficiency of O(n) rather than O(n²) in terms of Big-O notation, even when using cosine similarity as the similarity measure, due to a reduction in pair-wise comparisons (e.g., as a result of mapping the specific article to a relatively small number of coherent clusters).

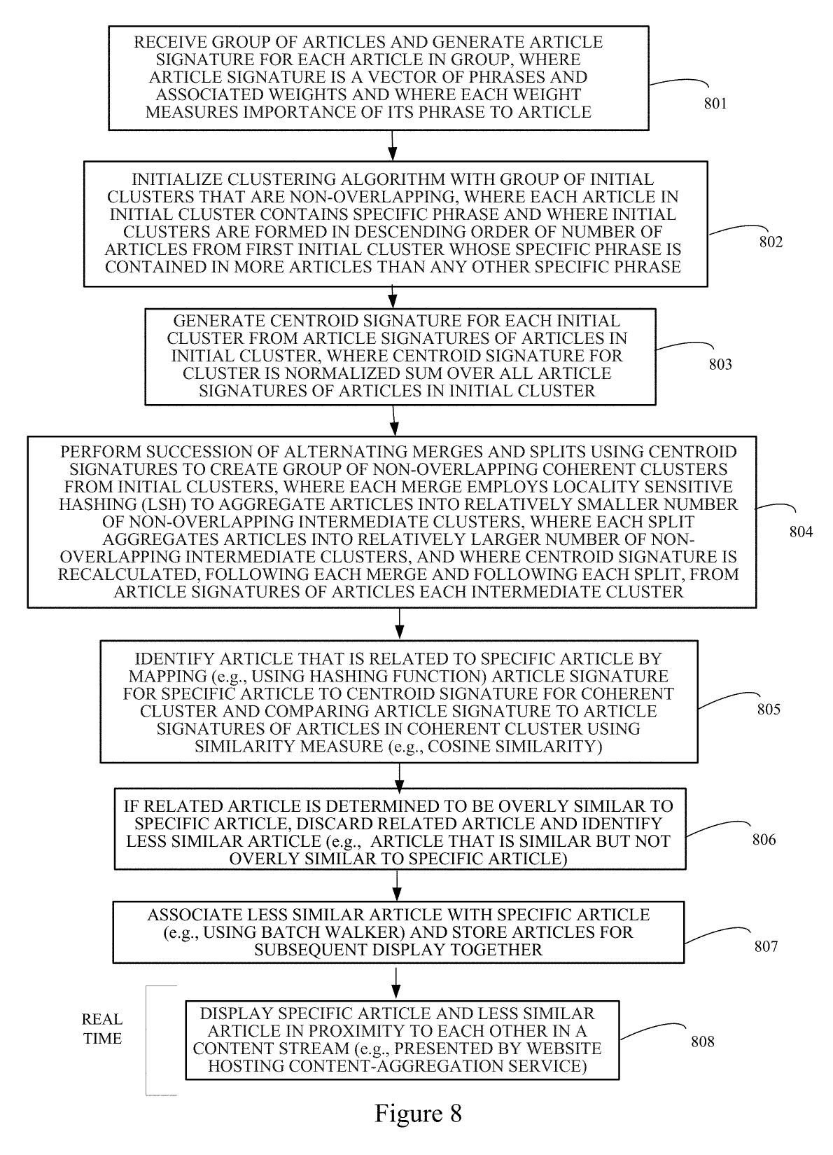

FIG. 8 is a flowchart diagram of a process for finding related articles, using a batch walker, to remove from a content stream, in accordance with an example embodiment. In an example embodiment, the operations shown in this figure might be performed by software running on servers at website 104 (e.g., Yahoo! News, Google News, Facebook, Twitter, etc.) using persistent storage 105. In an alternative example embodiment, some of the operations shown in this figure might be performed by software (e.g., a client application including, for example, a webpage with embedded JavaScript or ActionScript) running on a client device (e.g., personal computer 102 or mobile device 103).

As depicted in FIG. 8, the software (e.g., the software running on servers at website 104) receives a group of articles (e.g., from feeder 301 in FIG. 3) and generates an article signature for each article in the group, in operation 801. In an example embodiment, the article signature is a vector of phrases (e.g., one or more words) and associated weights, where each weight measures the importance of its associated phrase to the article. In operation 802, the software initializes a clustering algorithm with a group of initial clusters that are non-overlapping. In an example embodiment, each article in an initial cluster contains a specific phrase (e.g., “charleston massacre”) and the initial clusters are formed in descending order of number of articles (e.g., 210, 156, 75, etc.) from a first initial cluster whose specific phrase (e.g., “charleston massacre”) is contained in more articles than any other specific phrase. In operation 803, the software generates a centroid signature for each initial cluster from the article signatures of the articles in the initial cluster. In an example embodiment, the centroid signature for a cluster is a normalized sum over all of the article signatures of the articles in the initial cluster. The software then performs a succession of alternating merges and splits using the centroid signatures to create group of non-overlapping coherent clusters from the initial clusters, in operation 804. In an example embodiment, each merge employs locality sensitive hashing (LSH) to aggregate articles into a relatively smaller number of non-overlapping intermediate clusters and each split aggregates articles into a relatively larger number of non-overlapping intermediate clusters. It will be appreciated that LSH might utilize a number of hashing functions to map a single article to a number of clusters, in an example embodiment. The centroid signature is recalculated, following each merge and following each split, from the article signatures of the articles in each intermediate cluster, in an example embodiment. In operation 805, the software identifies an article that is related to a specific article (e.g., an article on the Charleston shooting) by mapping (e.g., using a hashing function) the article signature for the specific article to a centroid signature for a coherent cluster and comparing the article signature to the article signatures of the articles in the coherent cluster, using a similarity measure (e.g., cosine similarity). Then if the related article is determined to be overly similar to the specific article, the related article is discarded and a less similar (e.g., an article that is similar but not overly similar to the specific article) article is identified, in operation 806. The software associates the less similar article with the specific article (e.g., using batch walker 303 in FIG. 3) and stores the articles for subsequent display together in a content stream, in operation 807. Then in operation 808, the software displays the specific article (e.g., an article on the Charleston shooting) and the less similar article (e.g., another article on the Charleston shooting) in proximity to each other in a content stream (e.g., generated by the website hosting the content-aggregation service). As indicated in FIG. 8, operation 808 might be performed in real-time, in an example embodiment.

As noted above, the software, in operation 805, identifies an article that is related to a specific article by mapping (e.g., using a hashing function) the article signature for the specific article to a centroid signature for a coherent cluster and comparing the article signature to the article signatures of the articles in the coherent cluster, using a similarity measure (e.g., cosine similarity). In an example embodiment, an article in the coherent cluster might be deemed a “related article” if its article signature has a high value for pair-wise cosine similarity (e.g., in the range 0.7-0.9) to the article signature for the specific article. If the value for pair-wise cosine similarity is too high (e.g., over approximately 0.95, indicating that the important phrases in the article signature for the related article are the same as the important phrases in the article signature for the specific article), the software might discard the related article as a duplicate (or dup) and identify a related article that is not overly similar, in operation 806. In an example embodiment, a duplicate or (dup) might not be an exact duplicate.

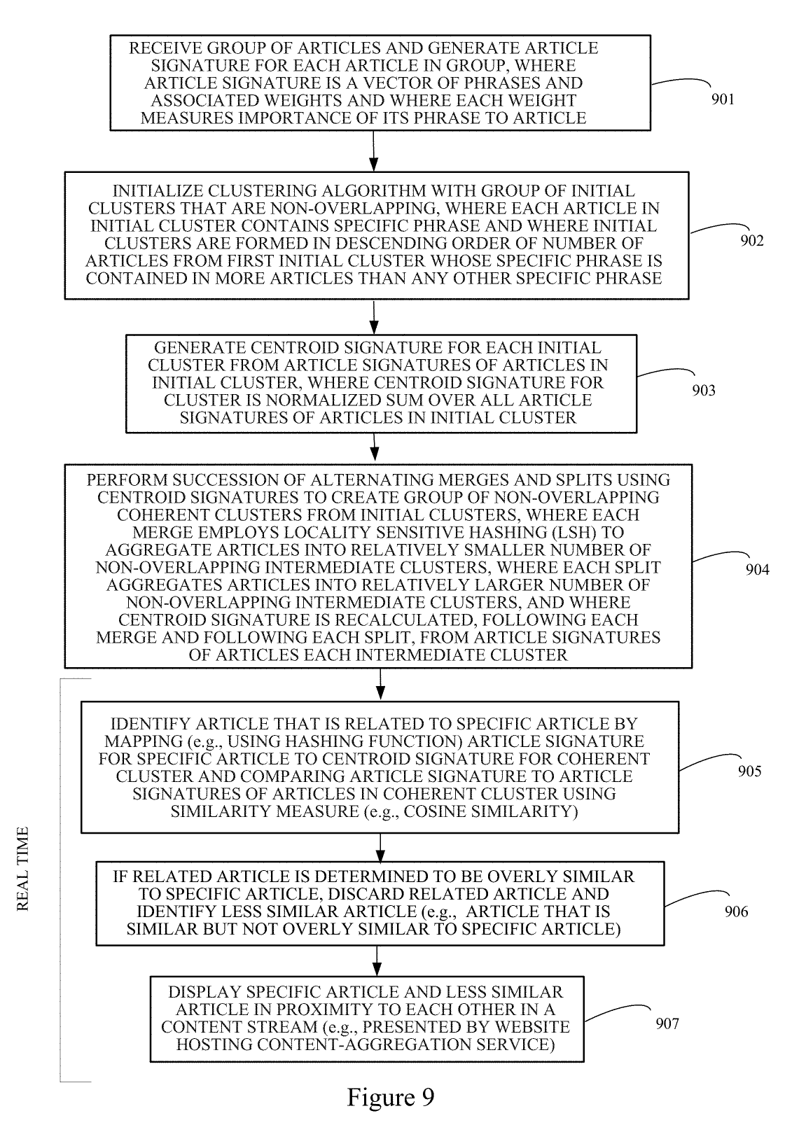

FIG. 9 is a flowchart diagram of a process for finding related articles, using an online walker, to remove from a content stream, in accordance with an example embodiment. In an example embodiment, the operations shown in this figure might be performed by software running on servers at website 104 (e.g., Yahoo! News, Google News, Facebook, Twitter, etc.) using persistent storage 105. In an alternative example embodiment, some of the operations shown in this figure might be performed by software (e.g., a client application including, for example, a webpage with embedded JavaScript or ActionScript) running on a client device (e.g., personal computer 102 or mobile device 103).

As depicted in FIG. 9, the software (e.g., the software running on servers at website 104) receives a group of articles (e.g., from feeder 301 in FIG. 3) and generates an article signature for each article in the group, in operation 901. In an example embodiment, the article signature is a vector of phrases (e.g., one or more words) and associated weights, where each weight measures the importance of its associated phrase to the article. In operation 902, the software initializes a clustering algorithm with a group of initial clusters that are non-overlapping. In an example embodiment, each article in an initial cluster contains a specific phrase (e.g., “charleston massacre”) and the initial clusters are formed in descending order of number of articles (e.g., 210, 156, 75, etc.) from a first initial cluster whose specific phrase (e.g., “charleston massacre”) is contained in more articles than any other specific phrase. In operation 903, the software generates a centroid signature for each initial cluster from the article signatures of the articles in the initial cluster. In an example embodiment, the centroid signature for a cluster is a normalized sum over all of the article signatures of the articles in the initial cluster. The software then performs a succession of alternating merges and splits using the centroid signatures to create group of non-overlapping coherent clusters from the initial clusters, in operation 904. In an example embodiment, each merge employs locality sensitive hashing (LSH) to aggregate articles into a relatively smaller number of non-overlapping intermediate clusters and each split aggregates articles into a relatively larger number of non-overlapping intermediate clusters. It will be appreciated that LSH might utilize a number of hashing functions to map a single article to a number of clusters, in an example embodiment. The centroid signature is recalculated, following each merge and following each split, from the article signatures of the articles in each intermediate cluster, in an example embodiment. In operation 905, the software identifies an article that is related to a specific article (e.g., an article on the Charleston shooting) by mapping (e.g., using a hashing function) the article signature for the specific article to a centroid signature for a coherent cluster and comparing the article signature to the article signatures of the articles in the coherent cluster, using a similarity measure (e.g., cosine similarity). Then if the related article is determined to be overly similar to the specific article, the software discards the related article and identifies a less similar (e.g., an article that is similar but not overly similar to the specific article) article, in operation 906. Then in operation 907, the software displays the specific article (e.g., an article on the Charleston shooting) and the less similar article (e.g., another article on the Charleston shooting) in proximity to each other in a content stream (e.g., generated by the website hosting the content-aggregation service). As indicated in FIG. 9, operations 905, 906, and 907 might be performed in real-time, in an example embodiment.

As noted above, the software, in operation 905, identifies an article that is related to a specific article by mapping (e.g., using a hashing function) the article signature for the specific article to a centroid signature for a coherent cluster and comparing the article signature to the article signatures of the articles in the coherent cluster, using a similarity measure (e.g., cosine similarity). In an example embodiment, an article in the coherent cluster might be deemed a “related article” if its article signature has a high value for pair-wise cosine similarity (e.g., in the range 0.7-0.9) to the article signature for the specific article. If the value for pair-wise cosine similarity is too high (e.g., over approximately 0.95, indicating that the important phrases in the article signature for the related article are the same as the important phrases in the article signature for the specific article), the software might discard the related article might as a duplicate (or dup) and identify a related article that is not overly similar, in operation 906. In an example embodiment, a duplicate or (dup) might not be an exact duplicate. In an example embodiment, operations 905 and 906 might be performed by online walker 304 in FIG. 3.

With the above embodiments in mind, it should be understood that the inventions might employ various computer-implemented operations involving data stored in computer systems. Any of the operations described herein that form part of the inventions are useful machine operations. The inventions also relate to a device or an apparatus for performing these operations. The apparatus may be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The inventions can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, DVDs, Flash, magnetic tapes, and other optical and non-optical data storage devices. The computer readable medium can also be distributed over a network coupled computer systems so that the computer readable code is stored and executed in a distributed fashion.

Although example embodiments of the inventions have been described in some detail for purposes of clarity of understanding, it will be apparent that certain changes and modifications can be practiced within the scope of the following claims. For example, the processes described above might be used to find related stories for a content stream presented by a website hosting an online social network, rather than a content-aggregation service. Or the processes described above might be used to find related patents rather than related stories, e.g., in a patent similarity engine (e.g., Lex Machina's Patent Similarity Engine). Indeed, any related texts would seem amenable to the processes described above. Also, the operations described above can be ordered, modularized, and/or distributed in any suitable way. Accordingly, the present embodiments are to be considered as illustrative and not restrictive, and the inventions are not to be limited to the details given herein, but may be modified within the scope and equivalents of the following claims. In the following claims, elements and/or steps do not imply any particular order of operation, unless explicitly stated in the claims or implicitly required by the disclosure.

What is claimed is:

1. A method, comprising operations of:
generating an article signature for each article in a plurality of articles, wherein the article signature is a vector of at least one phrase and a weight associated with the phrase and wherein the weight is a measure of importance of the phrase to the article;
initializing a clustering algorithm with a plurality of initial clusters that are non-overlapping, wherein each article in an initial cluster contains a specific phrase and wherein a centroid signature is generated for each initial cluster from the article signatures of the articles in the initial cluster;
performing a succession of alternating merges and splits using the centroid signatures to create a plurality of non-overlapping coherent clusters from the plurality of initial clusters, wherein each merge employs locality sensitive hashing (LSH) to aggregate articles into a relatively smaller number of non-overlapping intermediate clusters, wherein each split aggregates articles into a relatively larger number of non-overlapping intermediate clusters, and wherein the centroid signature is recalculated, following each merge and following each split, from the article signatures of the articles in each intermediate cluster;
identifying an article that is related to a specific article by mapping the article signature for the specific article to the centroid signature for at least one coherent cluster and comparing that article signature to the article signatures of the articles in the coherent cluster using at least one similarity measure; and
displaying the specific article and the related article in proximity to each other in a content stream; wherein each operation of the method is performed by one or more processors.

2. The method of claim 1, wherein the importance of the phrase is relatively increased if the phrase is a newsy token split from a uniform resource locator (URL) associated with the article.

3. The method of claim 1, wherein the identifying operation and the displaying operation are performed in real-time.

4. The method of claim 1, wherein the initial clusters are formed in a descending order of number of articles from a first initial cluster whose specific phrase is contained in more articles than any other specific phrase.

5. The method of claim 1, wherein the centroid signature for a cluster is a normalized sum over all of the article signatures of the articles in the cluster.

6. The method of claim 1, wherein the at least one of the merges uses a centroid signature that is expanded to include phrases from the relatively more important article signatures of the articles in the intermediate cluster.

7. The method of claim 1, wherein the at least one of the splits uses LSH to aggregate articles into a relatively larger number of intermediate clusters.

8. The method of claim 1, wherein the at least one of the splits uses cosine similarity to aggregate articles into a relatively larger number of intermediate clusters.

9. The method of claim 1, wherein the at least one similarity measure includes Jaccard similarity and cosine similarity.

10. One or more computer-readable media persistently storing instructions that, when executed by a processor, perform the following operations:
generate an article signature for each article in a plurality of articles, wherein the article signature is a vector of at least one phrase and a weight associated with the phrase and wherein the weight is a measure of importance of the phrase to the article;
initialize a clustering algorithm with a plurality of initial clusters that are non-overlapping, wherein each article in an initial cluster contains a specific phrase and wherein a centroid signature is generated for each initial cluster from the article signatures of the articles in the initial cluster;
performing a succession of alternating merges and splits using the centroid signatures to create a plurality of non-overlapping coherent clusters from the plurality of initial clusters, wherein each merge employs locality sensitive hashing (LSH) to aggregate articles into a relatively smaller number of non-overlapping intermediate clusters, wherein each split aggregates articles into a relatively larger number of non-overlapping intermediate clusters, and wherein the centroid signature is recalculated, following each merge and following each split, from the article signatures of the articles in each intermediate cluster;
identify an article that is related to a specific article by mapping the article signature for the specific article to the centroid signature for at least one coherent cluster and comparing that article signature to the article signatures of the articles in the coherent cluster using at least one similarity measure; and
display the specific article and the related article in proximity to each other in a content stream.

11. The computer-readable media of claim 10, wherein the importance of the phrase is relatively increased if the phrase is a newsy token split from a uniform resource locator (URL) associated with the article.

12. The computer-readable media of claim 10, wherein the identifying operation and the displaying operation are performed in real-time.

13. The computer-readable media of claim 10, wherein the initial clusters are formed in a descending order of number of articles from a first initial cluster whose specific phrase is contained in more articles than any other specific phrase.

14. The computer-readable media of claim 10, wherein the centroid signature for a cluster is a normalized sum over all of the article signatures of the articles in the cluster.

15. The computer-readable media of claim 10, wherein the at least one of the merges uses a centroid signature that is expanded to include phrases from the relatively more important article signatures of the articles in the intermediate cluster.

16. The computer-readable media of claim 10, wherein the at least one of the splits uses LSH to aggregate articles into a relatively larger number of intermediate clusters.

17. The computer-readable media of claim 10, wherein the at least one of the splits uses cosine similarity to aggregate articles into a relatively larger number of intermediate clusters.

18. The computer-readable media of claim 10, wherein the at least one similarity measure includes Jaccard similarity and cosine similarity.

19. A method, comprising operations of:
generating an article signature for each article in a plurality of articles, wherein the article signature is a vector of at least one phrase and a weight associated with the phrase and wherein the weight is a measure of importance of the phrase to the article;
initializing a clustering algorithm with a plurality of initial clusters that are non-overlapping, wherein each article in an initial cluster contains a specific phrase and wherein a centroid signature is generated for each initial cluster from the article signatures of the articles in the initial cluster;
performing a succession of alternating merges and splits using the centroid signatures to create a plurality of non-overlapping coherent clusters from the plurality of initial clusters, wherein each merge employs locality sensitive hashing (LSH) to aggregate articles into a relatively smaller number of non-overlapping intermediate clusters, wherein each split aggregates articles into a relatively larger number of non-overlapping intermediate clusters, and wherein the centroid signature is recalculated, following each merge and following each split, from the article signatures of the articles in each intermediate cluster;
identifying an article that is related to a specific article by mapping the article signature for the specific article to the centroid signature for at least one coherent cluster and comparing that article signature to the article signatures of the articles in the coherent cluster using at least one similarity measure;
determining that the related article is overly related to the specific article; and
removing the related article from a content stream in which the specific article is displayed, wherein each operation of the method is performed by one or more processors.

20. The method of claim 19, wherein the identifying operation and the removing operation are performed in real-time.
